(19) United States
(12) Patent Application Publication
(10) Pub. No.: US 2008/0005773 A1
(43) Pub. Date: Jan. 3, 2008

(54) Digital broadcast receiver and input switching method

(75) Inventor: Shingo Ikeda, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/812,935

(22) Filed: Jun. 22, 2007

(30) Foreign Application Priority Data
Jun. 30, 2006 (JP) 2006-182658

(51) Int. Cl. H04N 7/16; H04N 7/173

(52) U.S. Cl. 725/131; 725/139; 725/153; 725/37

(57) ABSTRACT

According to one embodiment, a digital broadcast receiver includes one or more first connecting terminals that connect one or more pieces of digital equipment, operation of which can be controlled by a remote control, one or more second connecting terminals that connect one or more pieces of external equipment, operation of which cannot be controlled by the remote control, and a selecting unit that selects, in turn, one piece of the digital equipment connected to the one or more first connecting terminals, the external equipment connected to the one or more second connecting terminals, the broadcast receiver, based on a switching instruction from the remote control. When the digital equipment connected to the first connecting terminal is selected by the selecting unit, a list of a plurality of video contents stored in the selected digital equipment is shown, and reproduction of a content selected from the list is controlled.

### CROSS-REFERENCE TO RELATED APPLICATIONS

This application is based upon and claims the benefit of priority from Japanese Patent Application No. 2006-182658, filed Jun. 30, 2006, the entire contents of which are incorporated herein by reference.

### BACKGROUND

1. Field

One embodiment of the invention relates to a digital broadcast receiver capable of connecting with external equipment that outputs a digital video signal in addition to external equipment that outputs a conventional analog video signal.

2. Description of the Related Art

In recent years, a digital broadcast receiver can receive a digital format signal from an HDMI terminal and/or a transport stream from equipment being connected to the digital broadcast receiver via a link of IEEE 1394 system or a LAN, in addition to an analog signal from a conventional external input terminal. That is, the recent digital broadcast receiver can connect with a variety of types of equipment including IEEE 1394 equipment, LANHDD equipment, and DLNA compatible equipment, in addition to conventional analog equipment, and can broadcast digital contents other than a digital broadcast.

A High-Definition Multimedia Interface (HDMI) is an input/output interface standard for a digital video and a digital audio used mainly for home electric appliances and audio visual equipment. The input/output interface standard is a standard that has been developed based on a digital interface used for connecting a personal computer and a display. The IEEE 1394 is one of transfer systems that connect a personal computer and peripheral digital video equipment.

A Digital Living Network Alliance (DLNA) indicates industrial organizations that establish technical specifications for connecting audio visual equipment, a personal computer, and home information appliances among each other, and for coordinating and utilizing the equipment, computer, and appliances by using a domestic LAN (home network). The DLNA may indicate the above technical specifications themselves. A Local Area Network HDD (LANHDD) also indicates technical specifications for connecting audio visual equipment and a personal computer that incorporate an HDD with each other and for coordinating and utilizing the equipment and computer by using a domestic LAN.

Jpn. Pat. Appln. Publication No. 2006-74614 discloses a broadcast receiving device that includes a first and a second LAN terminals, a USB terminal, and an IEEE 1394 terminal, displays a list of equipment connected to these terminals on a screen, selects a desired piece of digital equipment from the list on the screen, and reproduces a video content stored in the selected piece of equipment.

The IEEE 1394 equipment, the LANHDD equipment, and the DLNA compatible equipment have a feature that these types of equipment can be controlled by the digital broadcast receiver. However, the control of these types of equipment by the digital broadcast receiver has involved complicated operation and functions.

Further, different operation buttons need to be used for switching to conventional analog external input equipment and for switching to digital equipment such as the IEEE 1394 equipment, LANHDD equipment, and DLNA equipment that can be controlled by the digital broadcast receiver. Therefore, there is a problem that user has difficulty in intuitively operating the digital broadcast receiver.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of a digital broadcast receiver 10 to which the present invention is applied;

FIG. 2 is a view showing a transition of a screen of a monitor 23 by external equipment switching operation carried out by the user;

FIG. 3 is a view showing an allocation of a variety of buttons provided on a remote controller 32;

FIG. 4 shows a transition diagram of an equipment selecting and operating screen when IEEE 1394 equipment is selected by using an input switching button 32a;

FIG. 5 is a view showing a transition of the equipment selecting and operating screen when a transition is made to a LANHDD by using the input switching button 32a;

FIG. 6 is a view showing a transition of the equipment selecting and operating screen when a transition is made to a DLNA equipment by using the input switching button 32a; and

FIG. 7 is a view showing an equipment selecting screen 70 according to a second embodiment of the present invention.

### DETAILED DESCRIPTION

Various embodiments according to the invention will be described hereinafter with reference to the accompanying drawings. In general, according to one embodiment of the invention, there is provided a digital broadcast receiver capable of connecting with a plurality of pieces of external equipment including digital equipment capable of communicating information based on a communication protocol, comprising: a receiver that receives a digital broadcast; an operation unit that is used for inputting an instruction from the user to the digital broadcast receiver; one or more first connecting terminals that connect one or more pieces of digital equipment, operation of which can be controlled by the operation unit, with the digital broadcast receiver; one or more second connecting terminals that connect one or more pieces of external equipment, operation of which cannot be controlled by the operation unit, with the digital broadcast receiver; a selecting unit that selects, in turn, one piece of the digital equipment connected to the one or more first connecting terminals, the external equipment connected to the one or more second connecting terminals, and the receiver, based on a switching instruction from the operation unit; and a reproduction control unit that controls reproduction of a video content stored in the external equipment when the selecting unit selects the external equipment connected to the first connecting terminal, reproduces a video signal input from the external equipment when the selecting unit selects the external equipment connected to the second connecting terminal, and reproduces a video signal input from the receiver when the selecting unit selects the receiver.

According to the present embodiment, switching to conventional external input equipment, and switching to digital equipment including IEEE 1394 equipment, LANHDD equipment, and DLNA equipment which can be controlled by a digital broadcast receiver are integrated. Also, the present embodiment can provide intuitive and easy switching operation and control operation.

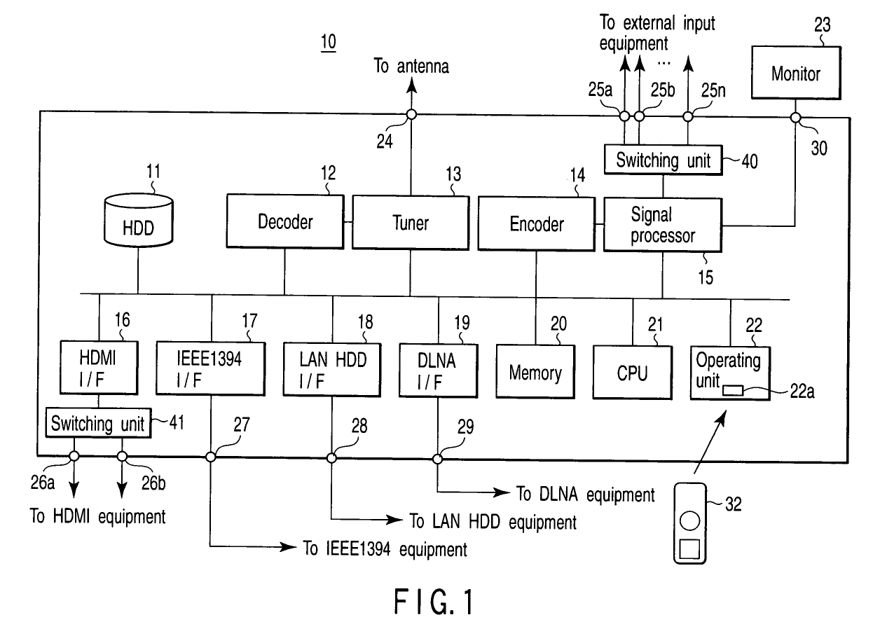

FIG. 1 is a block diagram showing a configuration of a digital broadcast receiver 10 to which the present invention is applied.

A tuner 13 receives a broadcast signal received by an antenna via an antenna input terminal 24. The tuner 13 extracts program data of a specific channel from the received broadcast signal. The tuner 13 is a digital tuner capable of receiving a digital broadcast including BS digital broadcasting and terrestrial digital broadcasting.

An HDMI I/F 16 works as an interface for HDMI equipment connected to an HDMI terminal 26a or 26b. A switching unit 41 selects one piece of the HDMI equipment connected via the HDMI terminals 26a and 26b under control of a CPU 21, and connects the selected piece of HDMI equipment and the HDMI I/F 16.

An IEEE 1394 I/F 17 works as an interface for IEEE 1394 equipment connected via an IEEE 1394 terminal 27. The IEEE 1394 I/F 17 can communicate with a plurality of pieces of the IEEE 1394 equipment connected with, for example, a link of a daisy chain system, via the terminal 27.

A LAN HDD I/F 18 works as an interface for a LAN HDD equipment connected via a terminal 28. The LAN HDD I/F 18 can communicate with the plurality of pieces of LAN HDD equipment on a network connected via the terminal 28.

A DLNA I/F 19 works as an interface for DLNA equipment connected via a DLNA terminal 29. The DLNA I/F 19 can communicate with the plurality of pieces of DLNA equipment on a network connected via the DLNA terminal 29.

As described above, digital equipment such as the IEEE 1394 equipment, the LAN HDD equipment, and the DLNA equipment can carry out information communication based on a communication protocol unique to each type of the equipment. The user can control operation of these types of digital equipment from a side of the digital broadcast receiver 10 via an operation unit 22 as described later, by utilizing the information communication function.

A decoder 12 decodes (expands) compressed data provided from the tuner 13, a variety of interfaces 16 to 19, or an HDD 11.

A signal processor 15, for example, D/A-converts and amplifies video and audio data decoded by the decoder 12, and reproduces a video signal and an audio signal. A monitor 23 displays a video based on the video signal provided by the signal processor 15 via a terminal 30, and an audio based on the audio signal provided thereby. The monitor 23 may be included in the digital broadcast receiver. Alternatively, the monitor 23 may externally connected to the digital broadcast receiver via a cable.

A switching unit 40 selects one piece of external input equipment connected via external input terminals 25a to 25n under control of the CPU 21, and supplies an analog signal from the selected piece of external input equipment to the signal processor 15. The signal processor 15 carries out signal processing such as amplifying and filtering of the analog signal from the external input equipment being input, and provides the processed signal to the monitor 23. When the analog signal from the external input equipment is recorded, the analog signal is, for example, A/D-converted in the signal processor 15 and encoded (compressed) by the encoder 14, and then recorded in the HDD 11. In addition, the HDD 11 records an encoded video and audio data provided by a variety of the interfaces 16 to 19.

Here, the external input equipment indicates video equipment that outputs analog video and audio signals. The external input terminals 25a to 25n include an S terminal and a D terminal in addition to a normal analog video terminal. The S terminal is a terminal that inputs a composite signal including a video signal separated into a luminance signal (Y) and a color-difference signal (C). The D terminal is a terminal that combines into one connector a component signal of Y/Pb/Pr including the color-difference signal being further separated into a color difference (Pb or Cb) of blue and a color difference (Pr or Cr) of red, and an identification signal that designates the number of scanning lines, a scan mode, and an aspect ratio. There are D1 to D4 as a type of the D terminal depending on the number of scanning lines and the scan mode.

The operation unit 22 is a user interface, and has a variety of buttons that receive a variety of input operations from the user and a receiver 22a that receives a signal transmitted from a remote controller 32. The user can operate the digital broadcast receiver 10 by using the operation unit 22 or the remote controller 32.

A memory 20 includes a ROM that stores a variety of control programs and a RAM used as a work area of the CPU 21. The CPU 21 executes a control program recorded in the memory 20 in accordance with an instruction input by the user via the operation unit 22.

Next, input switching processing according to an embodiment of the present invention will be described.

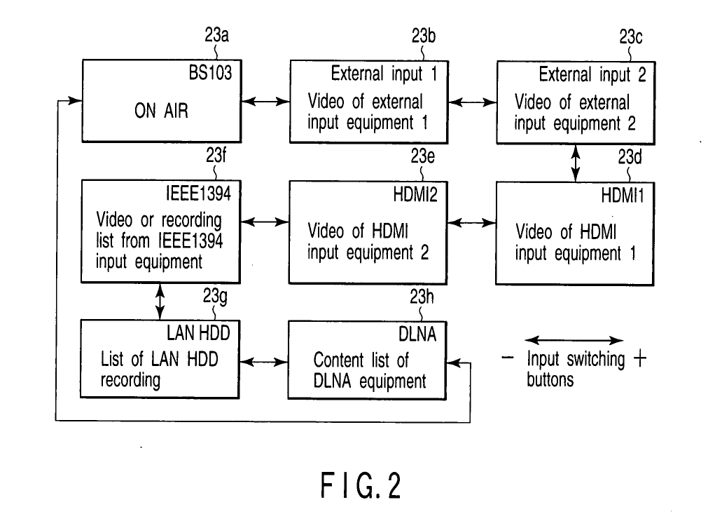

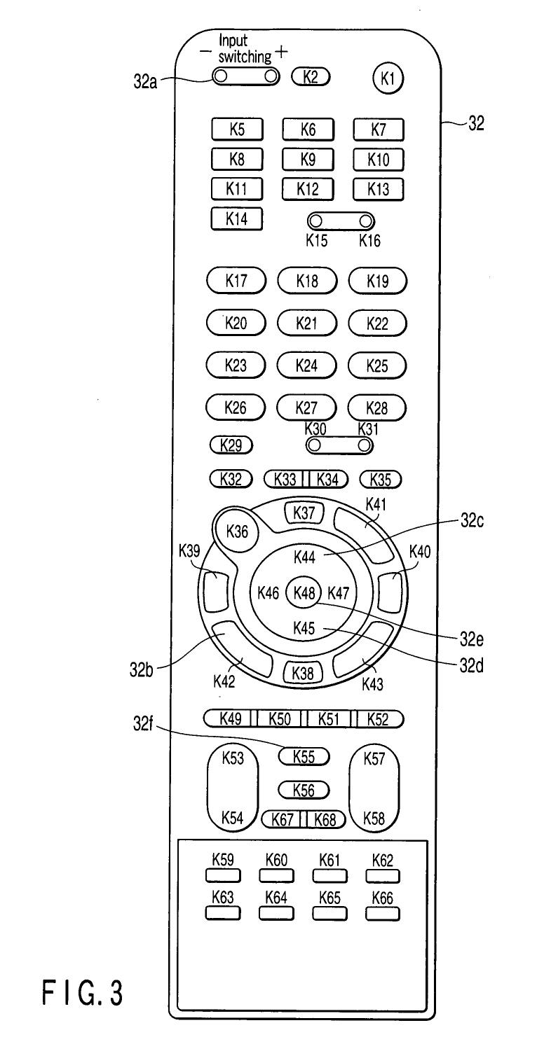

FIG. 2 is a view showing a transition of a screen of the monitor 23 corresponding to switching operation of an input in external equipment by the user. FIG. 3 is a view showing an allocation of a variety of buttons provided on the remote controller 32.

Here, the monitor 23 is assumed to be displaying a video 23a received by the tuner 13. When the user presses “+” side of an input switching button 32a of the remote controller 32, a connection switches to the external input equipment. That is, the CPU 21 selects a signal from the connected external input equipment connected to an external input terminal 25a in the switching unit 40, processes the selected signal in the signal processor 15, and displays a screen 23b on the monitor 23. The screen 23b displays an input name of a switching destination on an upper right part on the screen. When an external input terminal is the D terminal, input types of D1 to D4 are displayed. When an input switching button 32a is a seesaw type as shown in FIG. 3, a transition is made to a screen 23c of a next piece of the external input equipment (equipment connected to a terminal 25b) by pressing a forward direction (+) button, and to the screen 23a of the equipment before the switching (tuner 13) by pressing a return direction (−). When the input switching button 32a is a one-button type, a transition is made to a forward direction only. Transition of screens and selected connecting terminals is made in the order of the external input equipment (terminals 25a to 25n), the HDMI equipment (terminals 26a, 26b), the IEEE 1394 equipment (terminal 27), the LANHDD equipment (terminal 28), the DLNA equipment (terminal 29), and the tuner 13. For example, when the IEEE 1394 equipment (terminal 27) is selected by operation of the switching button 32a, the CPU 21 operates the IEEE 1394 I/F 17 and carries out communication with the IEEE 1394 equipment.

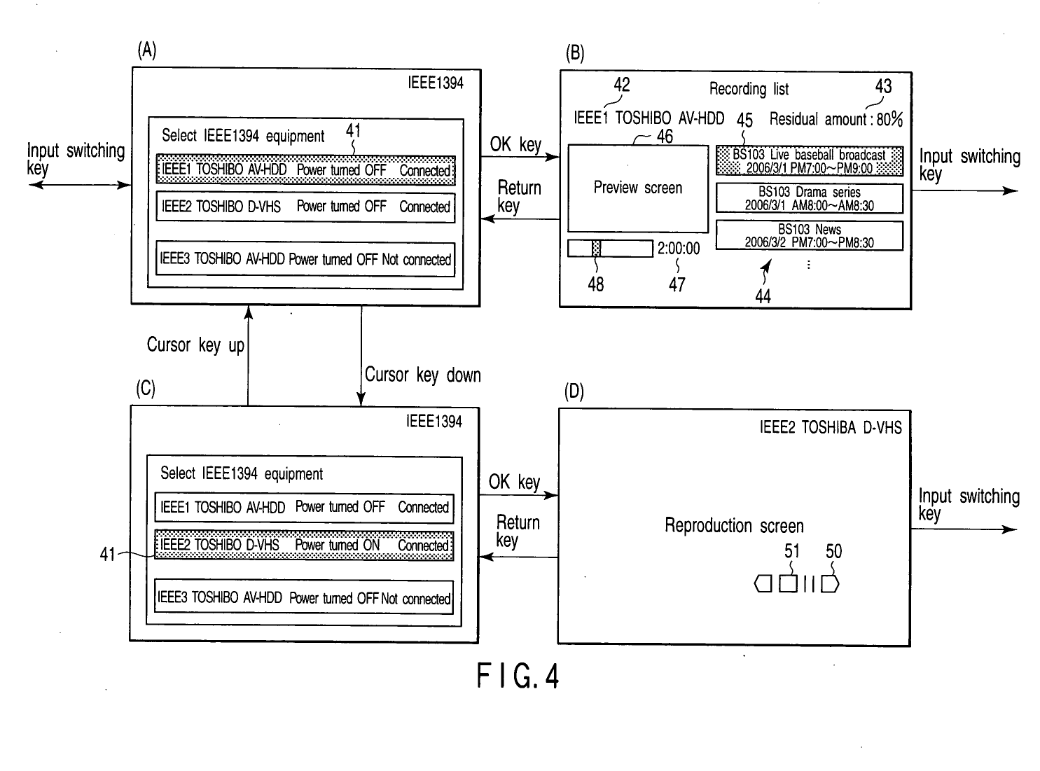

FIG. 4 is a view of transition of equipment selecting and operating screen when the IEEE 1394 equipment (IEEE 1394 I/F 17) is selected.

When a plurality of pieces of IEEE 1394 equipment are connected, the CPU 21 displays a list of the IEEE 1394 equipment for selecting equipment as shown in FIG. 4(A). The list shows equipment identification information, a manufacturer's name, equipment name, a power source status, and a connection status with respect to each piece of IEEE 1394 equipment. At this stage, the user can turn on or turn off a power source of equipment shown by a cursor 41 identified by a different color. The IEEE 1394 equipment is specified by moving the cursor 41 by cursor up and down buttons (that is, keys) 32c and 32d, and pressing an OK button 32e. A screen to be shown is different depending on whether the specified equipment is a disk device or a tape device.

When the specified equipment is a disk device, the CPU 21 shows a recording list, that is, a list of recorded video contents, as shown in FIG. 4(B). The recording list includes a selected equipment name 42, a residual amount 43 of recording capacity, a list display 44 of channel identification information, a program name, program broadcasting date and time, and the like of recorded programs, a preview screen 46 that displays a reproduction video of a program selected by a cursor 45 identified by a different color, recording time 47 of the program being previewed, and a reproducing position displaying bar 48. When the user uses the up and down buttons 32c and 32d to select a program and presses the OK button 32e, reproduction (full-screen display) of the program indicated by the cursor 45 starts.

When a return button 32b is pressed while the recording list in FIG. 4(B) is displayed, the screen returns to the IEEE 1394 equipment list display screen of FIG. 4(A). In addition, when the input switching button 32a is pressed while the recording list shown in FIG. 4(B) is displayed, a transition is made to a next transition destination in the screen shown in FIG. 2. That is, when the input switching button 32a (−) is pressed, the screen 23e is displayed, and when the input switching button 32a (+) is pressed, a transition is made to a screen 23g.

When the tape device is selected as in the equipment selecting screen of FIG. 4(C), the CPU 21 shows a reproduction screen of the equipment as shown in FIG. 4(D). A name of the selected piece of equipment is displayed on an upper right part of the screen, and graphic user interfaces (GUIs) such as a reproduction button 50 and a stop button 51 are displayed together with a video from the selected piece of equipment being reproduced. The user can control reproduction, stop, and so on of the selected piece of equipment by using the GUIs. When the return button 32b is pressed while the reproduction screen is displayed as shown in FIG. 4(D), the screen returns to the equipment list display screen of FIG. 4(C). In addition, when the input switching button 32a is pressed while the reproduction screen of FIG. 4(D) is displayed, the transition is made to the next transition destination shown in FIG. 2 as described above.

In a case where only one piece of equipment is connected via the IEEE 1394 terminal 27, and when the user uses the input switching button 32a to select the IEEE 1394 equipment (IEEE 1394 transition screen 23f in FIG. 2), the CPU 21 skips displaying of the equipment selecting list of FIG. 4(A) or FIG. 4(C) and displays the recording list of FIG. 4(B) or the reproduction screen of FIG. 4(D) in accordance with a device type of the connected equipment.

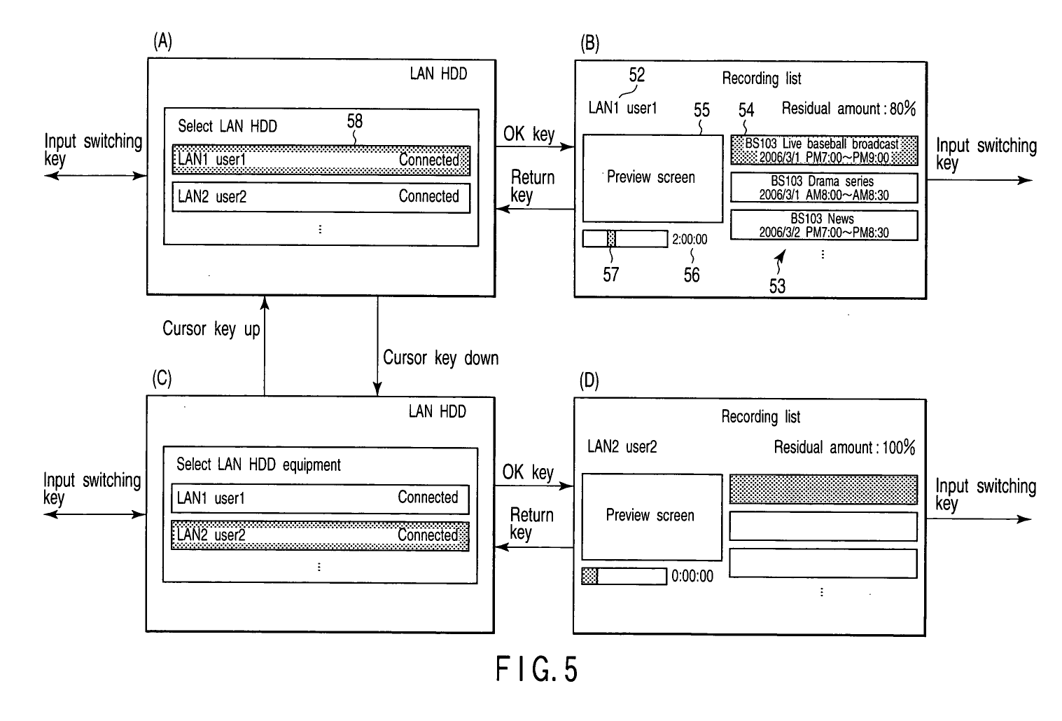

FIG. 5 is a view showing a transition of an equipment selecting and operating screen when a transition is made to a LANHDD by using the input switching button 32a.

In a case where a plurality of pieces of LANHDD equipment are connected via a LAN connected to a LANHDD terminal 28, and when the user uses the input switching button 32a to select a piece of LANHDD equipment (a LANHDD screen 23g in FIG. 2), the CPU 21 displays a LANHDD equipment list that is used for selecting the LANHDD equipment as shown in FIG. 5(A). Equipment identification (LAN 1 and the like), a device name (user 1 and the like), and a connection status of each piece of equipment are displayed in the list. The LANHDD equipment is selected by moving a cursor 58 identified by a different color by using the cursor up and down buttons 32c and 32d, and pressing the OK button 32e.

After the LANHDD equipment is selected, a recording list of the LANHDD equipment is shown as shown in FIG. 5(B). The recording list includes a name 52 of the selected equipment, a residual amount 52 of device capacity, a list display 53 of channel identification information, a program name, program broadcasting date and time, and the like of recorded programs, a preview screen 55 that displays a reproduction video of a program selected by a cursor 54 identified by a different color, recording time 56 of the program being previewed, and a reproducing position displaying bar 57.

When the return button 32b is pressed while the recording list in FIG. 5(B) is displayed, the screen returns to the LANHDD equipment list display screen of FIG. 5(A). In addition, when the input switching button 32a is pressed while the recording list shown in FIG. 5(B) is displayed, a transition is made to a next transition destination in the screen shown in FIG. 2.

In a case where only one piece of equipment is connected via the LANHDD terminal 28, and when the user uses the input switching button 32a to select the LANHDD equipment (LANHDD screen 23g in FIG. 2), the CPU 21 skips the equipment selecting list display like FIG. 5(A) and displays the recording list like FIG. 5(B).

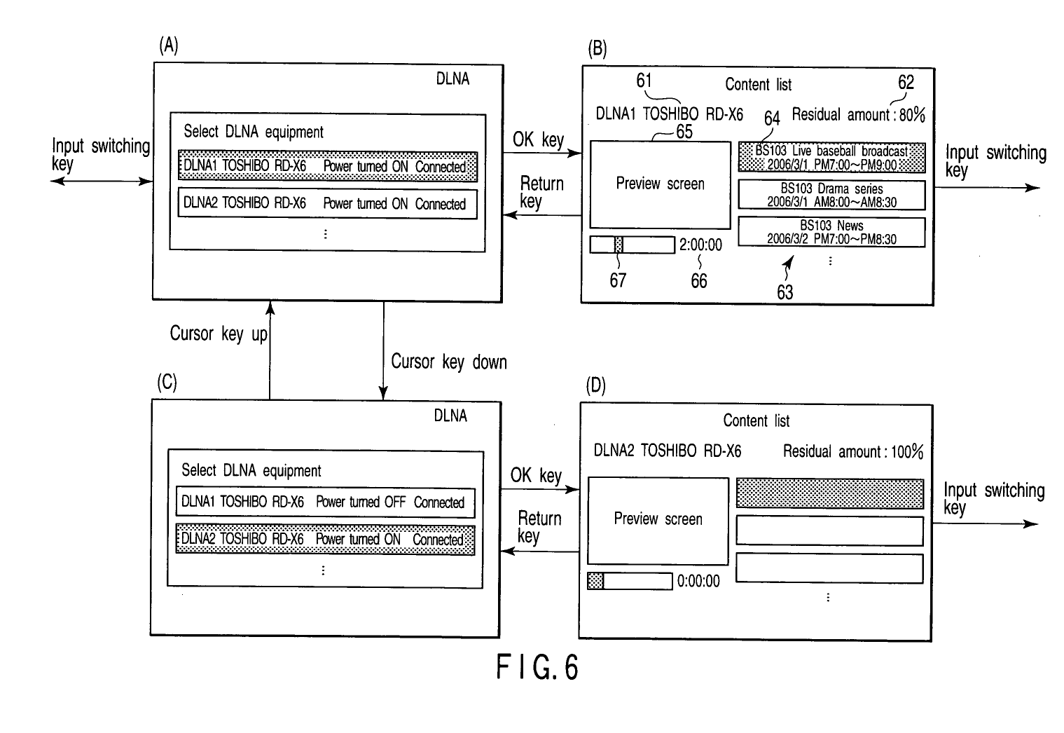

FIG. 6 is a view showing a transition of an equipment selecting and operating screen when a transition is made to DLNA equipment by using the input switching button 32a.

In a case where the plurality of pieces of DLNA equipment are connected via a LAN connected to the DLNA terminal 29, and when the user uses the input switching button 32a to select the DLNA equipment (a DLNA screen 23h in FIG. 2), the CPU 21 displays a DLNA equipment list that is used for selecting the DLNA equipment as shown in FIG. 6(A). Equipment identification (DLNA 1 and the like), a manufacturer's name (TOSHIBA and the like), equipment name (RD-X6 and the like), a power source status, and a connection status of each equipment are displayed in the list. The DLNA equipment is selected by moving a cursor 41 identified by a different color by using the cursor up and down buttons 32c and 32d, and pressing the OK button 32e.

After the DLNA equipment is selected, a content list of the DLNA equipment is shown as shown in FIG. 6(B). The content list includes a name 61 of the selected equipment, a residual amount 62 of device capacity, a list display 63 of channel identification information, a program name, program broadcasting date and time, and the like of recorded programs, a preview screen 65 that displays a reproduction video of a program selected by a cursor 64 identified by a different color, recording time 66 of the program being previewed, and a reproducing position displaying bar 67.

When the return button 32b is pressed while the content list in FIG. 6(B) is displayed, the screen returns to the DLNA equipment list display screen of FIG. 6(A). In addition, when the input switching button 32a is pressed while the recording list shown in FIG. 6(B) is displayed, a transition is made to a next transition destination in the screen shown in FIG. 2.

In a case where only one piece of equipment is connected via the DLNA terminal 29, and when the user uses the input switching button 32a to select the DLNA equipment (DLNAHDD screen 23h in FIG. 2), the CPU 21 skips the DLNA equipment selecting list display like FIG. 6(A) and displays the content list like FIG. 6(B).

Next, a second embodiment of input switching processing according to the present invention will be described. In the second embodiment, one piece of external equipment is selected from a list of all pieces of external equipment connected to the digital broadcast receiver 10.

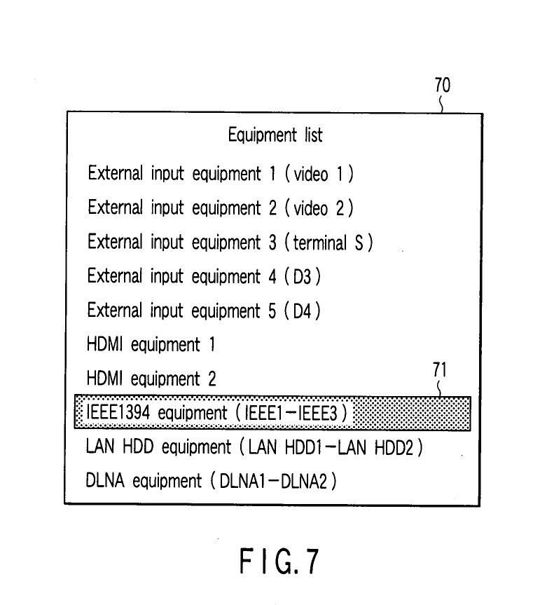

First, when the user presses external equipment selecting button 32f of the remote controller 32 shown in FIG. 3, the CPU 21 shows an equipment selecting screen 70 as shown in FIG. 7 on the monitor 23. External equipment indicated by a cursor 71 is selected by moving the cursor 71 by using the cursor up and down buttons 32c and 32d and pressing the OK button 32e. For example, as shown in FIG. 7, when the OK button 32e is pressed in a state where the IEEE 1394 equipment is indicated by the cursor 71, the IEEE 1394 equipment list of FIG. 4(A) described above is displayed.

Operation, in which one piece of the IEEE 1394 equipment is selected by pressing the OK button 32e after the cursor 41 is moved by using the cursor up and down buttons 32c and 32d in FIG. 4(A) or FIG. 4(B), and a recording list in a screen of FIG. 4(B) or a reproduction screen as shown in FIG. 4(D) is displayed, is similar to the one in the embodiment described above. In a case of the second embodiment, when the external equipment selecting button 32f is pressed while any of the screens shown in FIG. 4 is displayed, the display screen returns to the equipment list display of FIG. 7.

As described above, in the second embodiment, external equipment can be selected by using the equipment list 70. That is, in a state where the equipment list 70 is displayed, the user can intuitively grasp how many times the user needs to press the cursor up and down button 32c or 32d to select a target piece of external equipment. Therefore, selecting of external equipment is facilitated.

The above description is related to embodiments of the present invention, and is not to limit a device and a method of the present invention. A variety of modification examples can be easily made.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital broadcast receiver capable of connecting with a plurality of pieces of external equipment including digital equipment capable of communicating information based on a communication protocol, comprising:
a receiver that receives a digital broadcast;
an operation unit that is used for inputting an instruction from the user to the digital broadcast receiver;
one or more first connecting terminals that connect one or more pieces of digital equipment, operation of which can be controlled by the operation unit, with the digital broadcast receiver;
one or more second connecting terminals that connect one or more pieces of external equipment, operation of which cannot be controlled by the operation unit, with the digital broadcast receiver;
a selecting unit that selects, in turn, one piece of the digital equipment connected to the one or more first connecting terminals, the external equipment connected to the one or more second connecting terminals, and the receiver, based on a switching instruction from the operation unit; and
a reproduction control unit that controls reproduction of a video content stored in the external equipment when the selecting unit selects the external equipment connected to the first connecting terminal, reproduces a video signal input from the external equipment when the selecting unit selects the external equipment connected to the second connecting terminal, and reproduces a video signal input from the receiver when the selecting unit selects the receiver.

2. The digital broadcast receiver according to claim 1, wherein
when a plurality of pieces of IEEE 1394 equipment are connected to one of the first connecting terminals, operation of which can be controlled by the operation unit, via a link of a daisy chain system, and the one of the terminals is selected by the switching instruction from the operation unit, the reproduction control unit shows an equipment selecting list of the plurality of pieces of IEEE 1394 equipment, and when the IEEE 1394 equipment to be controlled is selected by the input of instruction from the operation unit from the list, the reproduction control unit shows a recording list of the IEEE 1394 equipment, and
when a single piece of the IEEE 1394 equipment is connected to one of the first connecting terminals and the one of the first connecting terminals is selected by the switching instruction from the operation unit, the reproduction control unit skips showing of the equipment selecting list of the IEEE 1394 equipment and presents the recording list of the IEEE 1394 equipment.

3. The digital broadcast receiver according to claim 1, wherein
when a plurality of pieces of LANHDD equipment are connected to one of the first connecting terminals, operation of which can be controlled by the operation unit, via a network, and the one of the first connecting terminals is selected by the switching instruction from the operation unit, the reproduction control unit shows an equipment selecting list of the plurality of pieces of LANHDD equipment, and when the LANHDD equipment to be controlled is selected from the list by the input of instruction from the operation unit, the reproduction control unit shows a recording list of the LANHDD equipment, and
when a single piece of the LANHDD equipment is connected to one of the first connecting terminals and the one of the first connecting terminals is selected by the switching instruction from the operation unit, the reproduction control unit skips showing of the equipment selecting list of the LANHDD equipment and shows the recording list of the LANHDD equipment.

4. The digital broadcast receiver according to claim 1, wherein
when a plurality of pieces of DLNA equipment are connected to one of the first connecting terminals, operation of which can be controlled by the operation unit, via a network, and the one of the first connecting terminals is selected by the switching instruction from the operation unit, the reproduction control unit shows an equipment selecting list of the plurality of pieces of DLNA equipment, and when the DLNA equipment to be controlled is selected from the list by the input of instruction from the operation unit, the reproduction control unit shows a recording list of the DLNA equipment, and
when a single piece of the DLNA equipment is connected to one of the first connecting terminals and the one of the first connecting terminals is selected by the switching instruction from the operation unit, the reproduction control unit skips showing of the equipment selecting list of the DLNA equipment and shows the recording list of the DLNA equipment.

5. A digital broadcast receiver capable of connecting with a plurality of pieces of external equipment including a digital equipment capable of communicating information based on a communication protocol, comprising:
a receiver that receives a digital broadcast;
an operation unit that is used for inputting an instruction from the user to the digital broadcast receiver;
one or more first connecting terminals that connect one or more pieces of the digital equipment, operation of which can be controlled by the operation unit, with the digital broadcast receiver;
one or more second connecting terminals that connect one or more pieces of external equipment, operation of which cannot be controlled by the operation unit, with the digital broadcast receiver;
a unit that shows a list of all pieces the external equipment including the digital equipment connected to the digital broadcast receiver in accordance with a first instruction from the operation unit;
a unit that selects, in turn, one piece of the external equipment shown in the list in accordance with a second instruction from the operation unit;
a setting unit that sets the external equipment selected by the selecting unit as external equipment to be reproduced in accordance with a setting instruction from the operation unit; and
a reproduction control unit that controls reproduction of a video content stored in the external equipment when the setting unit sets the external equipment connected to the first connecting terminal as the external equipment to be reproduced, reproduces a video signal input from the external equipment when the setting unit selects the external equipment connected to the second connecting terminal as the external equipment to be reproduced, and reproduces a video signal input from the receiver when the setting unit selects the receiver as the external equipment to be reproduced.

6. An input switching method that switches an input from external equipment in a digital broadcast receiver, having a receiver receiving a digital broadcast and an operation unit, connected to a plurality of pieces of the external equipment, comprising:
selecting, in turn, one of one or more pieces of external equipment, operation of which can be controlled by the operation unit, one or more pieces of external equipment, operation of which cannot be controlled by the operation unit, and the receiver; and
when the external equipment, operation of which can be controlled by the operation unit, is selected, controlling reproduction of a video content stored in such external equipment, when the external equipment, operation of which cannot be controlled by the operation unit, is selected, reproducing a video signal input from such external equipment, and when the receiver is selected, reproduces a video signal input from the receiver.
